(19) United States
(12) Patent Application Publication
(10) Pub. No.: US 2024/0313694 A1
(43) Pub. Date: Sep. 19, 2024

(54) INTERLOCKING SOLAR ROOF PANELS, METHOD OF INSTALLATION THEREOF, AND KIT

(71) Applicant: Mitrex Inc., Toronto (CA)

(72) Inventors: Travis Yeow, Mississauga (CA); Danial Hadizadeh, North York (CA)

(21) Appl. No.: 18/121,620

(22) Filed: Mar. 15, 2023

(51) Int. Cl. H02S 20/23; F24S 25/33

(52) U.S. Cl. CPC H02S 20/23; F24S 25/33; F24S 2025/601; F24S 2025/803; F24S 2025/804

(57) ABSTRACT

The present specification relates generally to solar roof panels and more specifically to an interlocking solar roof panel, method of installation thereof, and related kit. The interlocking solar roof panel comprises a rectangular frame, configured to hold a photovoltaic panel, wherein the rectangular frame has at least one free edge opposite at least one connecting edge; at least one male component, disposed at a point along the at least one connecting edge; at least one female component, disposed at a point along the at least one free edge and configured to connect with the at least one male component; and a photovoltaic panel. A kit comprising at least one interlocking solar roof panel and at least one bracket is also disclosed. The interlocking solar roof panel may increase the visual appeal of a series of solar roof panels installed on a roof.

### FIELD OF THE INVENTION

The present specification relates generally to solar roof panels and more specifically to an interlocking solar roof panel, method of installation thereof, and related kit.

### BACKGROUND OF THE INVENTION

Solar roof panels have long been touted for their ability to provide green, inexpensive energy to a building below. Despite their advantages, solar roof panels are not commonly encountered. Traditional solar roof panels lack visual appeal and are widely considered to detract from the design of a building. Depending on the style of roof to which they are applied, solar roof panels may be seen by people who are on a roof top equipped with these panels, people with a vantage point above the panelled roof top, and even people at street level. Traditional solar roof panels lack visual appeal for a number of reasons, including the prominent frames of these panels, the substantial clamps and bolts which fasten the panels to a roof, and the failure of these panels to blend into their surroundings.

As a result of their unsightliness, use of solar roof panels may be more limited than it would otherwise be. Further, due to the multiple different tools and components required to install existing solar roof panels, installation may be challenging and time consuming, mechanical failure may be more common, and maintenance may be more regularly required.

Accordingly, there remains a need for improvements in the art.

### SUMMARY OF THE INVENTION

The interlocking solar roof panel of the present invention may improve upon the aesthetics of traditional solar panels while minimizing the amount and variety of mounting hardware needed to install the panels.

In an embodiment of the present invention, there is provided an interlocking solar roof panel comprising a rectangular frame, configured to hold a photovoltaic panel, wherein the rectangular frame has at least one free edge opposite at least one connecting edge; at least one male component, disposed at a point along the at least one connecting edge; at least one female component, disposed at a point along the at least one free edge and configured to connect with the male component; and a photovoltaic panel.

According to another embodiment, there is provided an interlocking solar roof panel kit comprising at least one interlocking solar roof panel, wherein the at least one interlocking solar roof panel comprises a rectangular frame, configured to hold a photovoltaic panel, wherein the rectangular frame has at least one free edge opposite at least one connecting edge, at least one male component, disposed at a point along the at least one connecting edge, at least one female component, disposed at a point along the at least one free edge and configured to connect with the at least one male component, and a photovoltaic panel; and at least one bracket.

According to a further embodiment, there is provided a method of installing interlocking solar roof panels comprising applying a first interlocking solar roof panel to a solar rail; fixing at least one edge of the first interlocking solar roof panel to the solar rail; connecting a second interlocking solar roof panel to the first interlocking solar roof panel by interlocking a female component on the second interlocking solar roof panel with a male component on the first interlocking solar roof panel.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a top plan view of an interlocking solar roof panel, according to an embodiment;

FIG. 2 is a bottom plan view of the interlocking solar roof panel of FIG. 1;

FIG. 3 is a front plan view of the interlocking solar roof panel of FIG. 1;

FIG. 4 is a rear plan view of the interlocking solar roof panel of FIG. 1;

FIG. 5 is a front plan view of an at least one bracket, according to an embodiment;

FIG. 6 is a rear plan view of the at least one bracket of FIG. 5;

FIG. 7 is a bottom perspective view of the at least one bracket of FIG. 5;

FIG. 8 is a front perspective view of the at least one bracket of FIG. 5;

FIG. 9 is a right plan view of the interlocking solar roof panel of FIG. 1; and

FIG. 10 is a left plan view of the interlocking solar roof panel of FIG. 1.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and, in some instances, proportions may have been exaggerated in order more clearly to depict certain features of the invention.

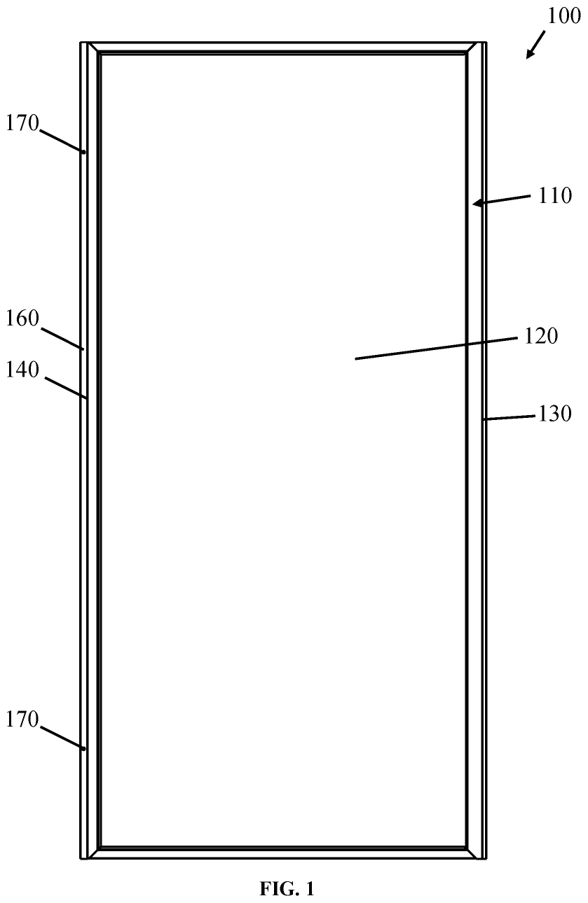

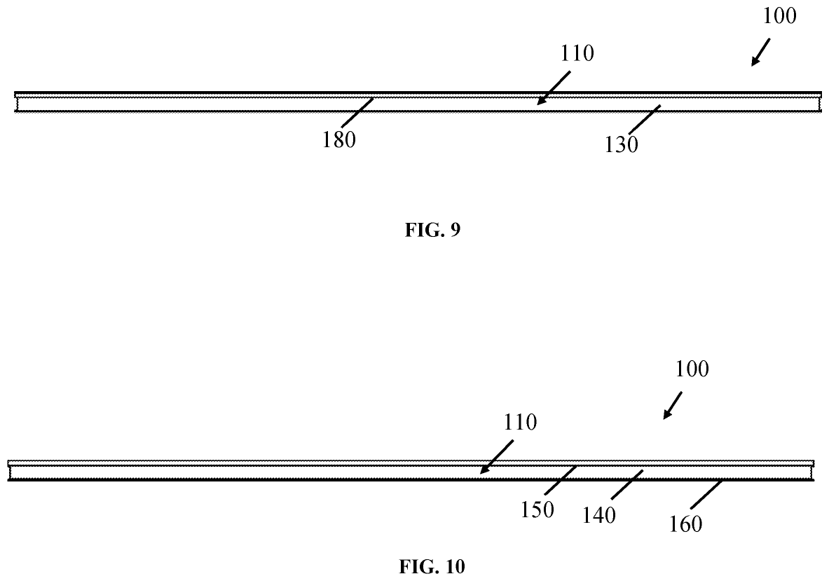

According to an embodiment, as shown in FIGS. 1-4, 9 and 10, an interlocking solar roof panel 100 is provided to improve upon the appearance and visual appeal of one or more solar roof panels installed on a roof. Accordingly, interlocking solar roof panel 100 may increase the prevalence of solar roof panel use and “green” energy production, and may further reduce the damaging environmental effects of alternative energy sources. Interlocking solar roof panel 100 may also reduce the costs associated with powering a home or other structure by eliminating a disadvantage associated with their use which would otherwise deter landlords and property owners from installing solar roof panels. Interlocking solar roof panel 100 is also provided to reduce a quantity of mounting hardware required for the installation of one or more solar roof panels. Accordingly, interlocking solar roof panel 100 may improve case of installation of one or more solar roof panels and may further limit a number of failure points along one or a series of solar roof panels. Interlocking solar roof panel 100 may also reduce a frequency of maintenance of one or a series of solar roof panels.

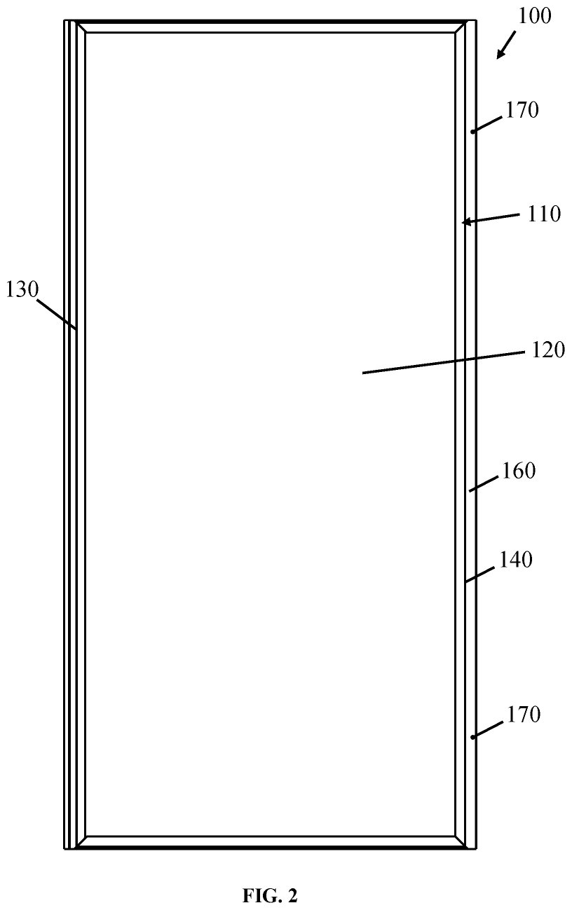

According to an embodiment, as shown in FIGS. 1 and 2, interlocking solar roof panel 100 comprises a rectangular frame 110, configured to hold a photovoltaic panel 120, wherein the rectangular frame has at least one free edge 130 opposite at least one connecting edge 140. Rectangular frame 110 may vary in size and/or in rectangular shape. According to an embodiment, rectangular frame 110 is assembled by compression fitting a series of corner “keys” into a series of corresponding slots in rectangular frame 110. Rectangular frame 110 may be constructed of one or a combination of aluminum, thermoplastic, tin, and steel. According to an embodiment, photovoltaic panel 120 is adhered to rectangular frame 110 by way of a structural adhesive. The structural adhesive may be chosen from one of polyurethane, silicone or epoxy. According to an embodiment, photovoltaic panel 120 is one of a monocrystalline, polycrystalline, PERC, or a thin-film panel.

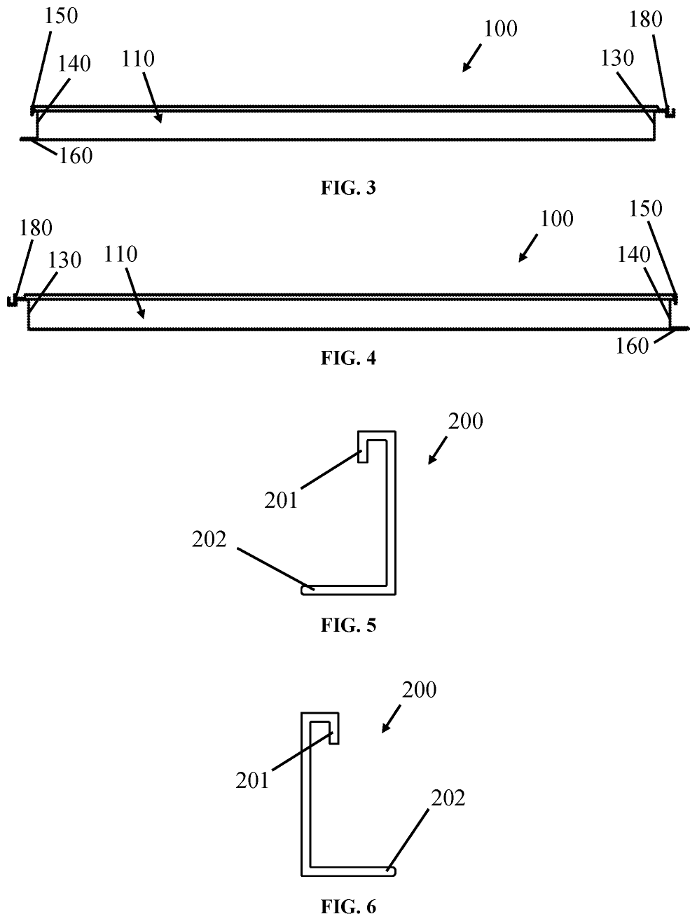

As shown in FIGS. 3, 4, and 10, interlocking solar roof panel 100 further comprises at least one male component 150, disposed at a point along at least one connecting edge 140. According to an embodiment, at least one male component 150 comprises one male component. According to a further embodiment, the one male component spans a full length of at least one connecting edge 140. At least one male component 150 may comprise one of at least one L-shaped lip and at least one T-shaped lip. As shown in FIGS. 1 and 2, at least one connecting edge 140 may comprise a lateral lip 160 and at least one fixing hole 170 in lateral lip 160. At least one connecting edge 140 may vary in length and in gauge.

Interlocking solar roof panel 100 further comprises at least one female component 180. disposed at a point along at least one free edge 130 and configured to connect with at least one male component 150, as shown in FIGS. 3, 4 and 9. According to an embodiment, at least one female component 180 comprises one female component. According to a further embodiment, the one female component spans a full length of at least one free edge 130. At least one female component 180 may comprise one of at least one U-shaped channel and at least one C-shaped channel. A shape of at least one female component 180 may be selected to correspond and mate with a shape of at least one male component 150. At least one free edge 130 may vary in length and in gauge.

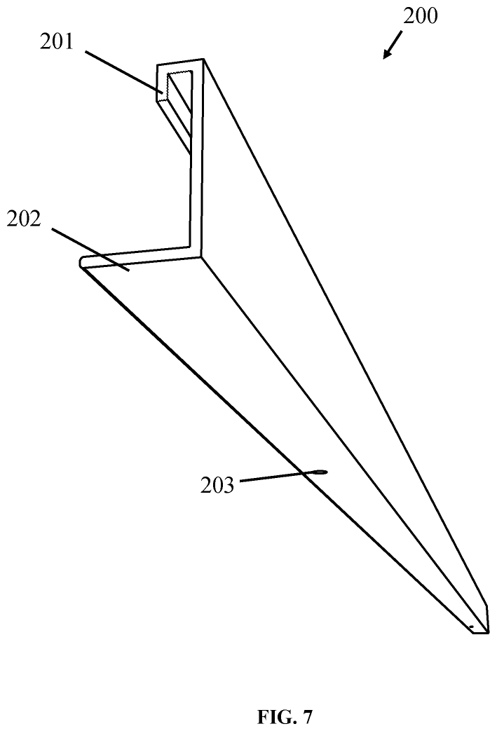

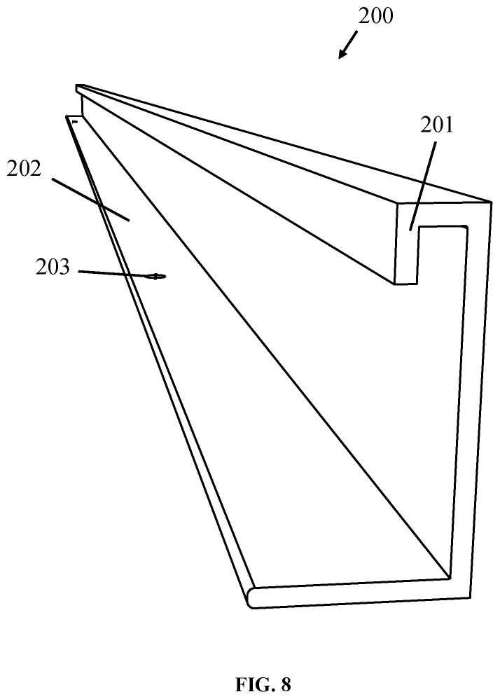

According to an embodiment, there is provided an interlocking solar roof panel kit comprising: at least one interlocking solar roof panel, wherein the at least one interlocking solar roof panel comprises a rectangular frame, configured to hold a photovoltaic panel, wherein the rectangular frame has at least one free edge opposite at least one connecting edge, at least one male component, disposed at a point along the at least one connecting edge, at least one female component, disposed at a point along the at least one free edge and configured to connect with the at least one male component; a photovoltaic panel; and at least one bracket 200. As shown in FIGS. 5-8, at least one bracket 200 may facilitate the secure installation of the at least one interlocking solar roof panel by providing an abutment for the at least one interlocking solar roof panel. At least one bracket 200 may further provide an additional point of attachment for the at least one interlocking solar roof panel. At least one bracket 200 may also improve the appearance of the at least one interlocking solar roof panel installed on a roof by providing a border and/or concealing unsightly hardware. According to an embodiment, at least one bracket 200 comprises one of a male connector 201 and a female connector (not shown). According to another embodiment, as shown in FIGS. 7 and 8, at least one bracket 200 comprises a fixing edge 202 having at least one fixing hole 203. At least one bracket 200 may be L-shaped, as shown in FIGS. 5-8. According to an embodiment, the interlocking solar roof panel kit further comprises at least one solar rail.

According to an embodiment, there is provided a method of installing interlocking solar roof panels comprising: applying a first interlocking solar roof panel to a solar rail; fixing at least one edge of the first interlocking solar roof panel to the solar rail; connecting a second interlocking solar roof panel to the first interlocking solar roof panel by interlocking a female component on the second interlocking solar roof panel with a male component on the first interlocking solar roof panel. The step of fixing at least one edge of the first interlocking solar roof panel to the solar rail may comprise fastening a bolt to the solar rail through a fixing hole in the at least one edge of the first interlocking solar roof panel. According to an embodiment, the step of connecting the second interlocking solar roof panel to the first interlocking solar roof panel by interlocking a female component on the second interlocking solar roof panel with a male component on the first interlocking solar roof panel comprises: tilting the second interlocking solar roof panel toward the first interlocking solar roof panel at an acute angle to a surface of the roof; positioning the female component on the second interlocking solar roof panel next to and below the male component of the first interlocking solar roof panel; lowering a raised edge of the second interlocking solar roof panel toward the surface of the roof such that the female component captures within it the male component.

According to an embodiment, the method of installing interlocking solar roof panels further comprises fixing an edge of the second interlocking solar roof panel opposite the first interlocking solar roof panel to the solar rail.

According to yet another embodiment, the method of installing interlocking solar roof panels further comprises fixing a bracket to the solar rail. The step of fixing a bracket to the solar rail may comprise fastening a T-nut to the solar rail through a fixing hole in an edge of the bracket

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

1. An interlocking solar roof panel comprising:
a rectangular frame, configured to hold a photovoltaic panel, wherein the rectangular frame has at least one free edge opposite at least one connecting edge;
at least one male component, disposed at a point along the at least one connecting edge;
at least one female component, disposed at a point along the at least one free edge and configured to connect with the at least one male component; and
a photovoltaic panel.

2. The roof panel of claim 1, wherein the at least one male component comprises one male component.

3. The roof panel of claim 2, wherein the one male component spans a full length of the at least one connecting edge.

4. The roof panel of claim 1, wherein the at least one female component comprises one female component.

5. The roof panel of claim 4, wherein the one female component spans a full length of the at least one free edge.

6. The roof panel of claim 1, wherein the at least one connecting edge comprises:
a lateral lip; and
at least one fixing hole in the lateral lip.

7. The roof panel of claim 1, wherein the at least one female component comprises one of at least one U-shaped channel and at least one C-shaped channel.

8. The roof panel of claim 1, wherein the at least one male component comprises one of at least one L-shaped lip and at least one T-shaped lip.

9. The roof panel of claim 1, wherein the photovoltaic panel is adhered to the rectangular frame by way of a structural adhesive.

10. An interlocking solar roof panel kit comprising:
at least one interlocking solar roof panel, wherein the at least one interlocking solar roof panel comprises:
a rectangular frame, configured to hold a photovoltaic panel, wherein the rectangular frame has at least one free edge opposite at least one connecting edge,
at least one male component, disposed at a point along the at least one connecting edge,
at least one female component, disposed at a point along the at least one free edge and configured to connect with the at least one male component, and
a photovoltaic panel; and
at least one bracket.

11. The kit of claim 10, wherein the at least one bracket comprises one of a male connector and a female connector.

12. The kit of claim 11, wherein the at least one bracket further comprises a fixing edge having at least one fixing hole.

13. The kit of claim 12, wherein the at least one bracket is L-shaped.

14. The kit of claim 10, further comprising at least one solar rail.

15. A method of installing interlocking solar roof panels comprising:
applying a first interlocking solar roof panel to a solar rail;
fixing at least one edge of the first interlocking solar roof panel to the solar rail;
connecting a second interlocking solar roof panel to the first interlocking solar roof panel by interlocking a female component on the second interlocking solar roof panel with a male component on the first interlocking solar roof panel.

16. The method of claim 15, further comprising:
fixing an edge of the second interlocking solar roof panel opposite the first interlocking solar roof panel to the solar rail.

17. The method of claim 15, further comprising:
fixing a bracket to the solar rail.

18. The method of claim 15, wherein the step of fixing at least one edge of the first interlocking solar roof panel to the solar rail comprises fastening a bolt to the solar rail through a fixing hole in the at least one edge of the first interlocking solar roof panel.

19. The method of claim 17, wherein the step of fixing a bracket to the solar rail comprises fastening a T-nut to the solar rail through a fixing hole in an edge of the bracket.

20. The method of claim 15, wherein the step of connecting the second interlocking solar roof panel to the first interlocking solar roof panel by interlocking a female component on the second interlocking solar roof panel with a male component on the first interlocking solar roof panel comprises:
tilting the second interlocking solar roof panel toward the first interlocking solar roof panel at an acute angle to a surface of the roof;
positioning the female component on the second interlocking solar roof panel next to and below the male component of the first interlocking solar roof panel; and
lowering a raised edge of the second interlocking solar roof panel toward the surface of the roof such that the female component captures within it the male component.
